(19) United States
(12) Patent Application Publication
(10) Pub. No.: US 2020/0391289 A1
(43) Pub. Date: Dec. 17, 2020

(54) ADDITIVE MANUFACTURING SYSTEMS AND METHODS INCLUDING CONTROLLABLE VANE THAT DIRECTS GAS FLOW

(71) Applicant: General Electric Company, Schenectady, NY (US)

(72) Inventors: Scott Andrew Weaver, Ballston Lake, NY (US); Justin John Gambone, JR., Schenectady, NY (US)

(21) Appl. No.: 16/437,397

(22) Filed: Jun. 11, 2019

(51) Int. Cl. B22F 3/10; B22F 3/105; B33Y 10/00; B33Y 30/00; B33Y 50/02

(52) U.S. Cl. CPC B22F 3/1007; B22F 3/1055; B22F 2003/1057; B33Y 30/00; B33Y 50/02; B33Y 10/00

(57) ABSTRACT

Methods and systems for fabricating a component include a build platform configured to receive a particulate, a consolidation device configured to consolidate the particulate to form a component, and a gas supply configured to provide a gas flow across the build platform. The additive manufacturing system also includes at least one vane positionable in a plurality of orientations relative to the gas flow. The additive manufacturing system further includes an actuator system coupled to the at least one vane and configured to move the at least one vane between the plurality of orientations. The additive manufacturing system also includes at least one sensor and a control system configured to receive information from the at least one sensor and cause the at least one vane to move between the plurality of orientations based on the information received from the at least one sensor.

### BACKGROUND

The subject matter described herein relates generally to additive manufacturing systems and, more particularly, to additive manufacturing systems including a controllable vane that directs gas flow across a build platform.

At least some known additive manufacturing systems involve the consolidation of a particulate to fabricate a component. Such techniques facilitate producing complex components from expensive materials at a reduced cost and with improved manufacturing efficiency. At least some known additive manufacturing systems, such as Direct Metal Laser Melting (DMLM), Selective Laser Melting (SLM), Direct Metal Laser Sintering (DMLS), and LaserCUSING® systems, fabricate components using a focused energy source, such as a laser device or an electron beam generator, a build platform, and a particulate, such as, without limitation, a powdered metal. (LaserCUSING is a registered trademark of Concept Laser GmbH of Lichtenfels, Germany.)

At least some known additive manufacturing systems include a housing that at least partially encloses a build platform and defines an environment for fabrication of the component on the build platform. During operation of the additive manufacturing systems, the environment around the component is controlled to provide desired characteristics of the component and to prevent contamination of the component. For example, at least some known additive manufacturing systems include a gas supply that provides a gas flow across the build platform during fabrication of the component. The gas flow removes particles from the environment that could be deposited on the component during fabrication. In addition, the gas flow reduces the temperature of the environment during fabrication of the component and facilitates heat transfer between the particulate/component and the environment during the consolidation process. However, in at least some known additive manufacturing systems, the conditions of the environment around the particulate/component vary throughout the fabrication process. Accordingly, the gas flow may be insufficient and/or excessive for the conditions of the environment in at least some locations of the environment during at least a portion of the fabrication process. Moreover, in at least some known additive manufacturing systems, components of the additive manufacturing system such as the housing interfere with the gas flow and prevent the gas flow from providing desired environmental conditions during at least a portion of the fabrication process.

Accordingly, there is a need for an improved additive manufacturing system that allows for control of the environment within the build chamber during fabrication of a component.

### BRIEF DESCRIPTION

In one aspect, an additive manufacturing system is provided. The additive manufacturing system includes a build platform configured to receive a particulate, a consolidation device configured to consolidate the particulate to form a component, and a gas supply configured to provide a gas flow across the build platform. The additive manufacturing system also includes at least one vane positionable in a plurality of orientations relative to the gas flow. The additive manufacturing system further includes an actuator system coupled to at least one vane and configured to move the at least one vane between the plurality of orientations. The additive manufacturing system also includes at least one sensor and a control system configured to receive information from the at least one sensor and cause the at least one vane to move between the plurality of orientations based on the information received from the at least one sensor.

In another aspect, a method of fabricating a component using an additive manufacturing system is provided. The method includes depositing a particulate onto a build platform of the additive manufacturing system, directing a gas flow across the build platform, and positioning at least one vane in a first orientation relative to the gas flow. The method also includes consolidating the particulate on the build platform and determining an operating parameter of the additive manufacturing system using information received from at least one sensor. The method further includes determining a second orientation of the at least one vane based on the operating parameter and positioning the at least one vane in the second orientation relative to the gas flow.

In yet another aspect, an additive manufacturing system is provided. The additive manufacturing system includes a build platform configured to receive a particulate, a gas supply configured to provide a gas flow across the build platform, and a housing surrounding the build platform and defining an environment for forming a component. The housing includes an inlet to receive the gas flow into the environment from the gas supply and an outlet for the gas flow to exit the environment. The additive manufacturing system also includes at least one vane movably coupled to the housing and disposed within the environment. The at least one vane is positionable in a plurality of orientations relative to the gas flow. The additive manufacturing system further includes a control system configured to determine at least one operating parameter of the additive manufacturing system and move the at least one vane between the plurality of orientations based on the operating parameter.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an exemplary additive manufacturing system including a vane that directs gas flow across a build platform;

FIG. 2 is a schematic diagram of gas flow during operation of the additive manufacturing system shown in FIG. 1 with the vane located at a distance from an inlet and an outlet;

FIG. 3 is a schematic diagram of gas flow during operation of the additive manufacturing system shown in FIG. 1 with the vane located adjacent a wall of a housing of the additive manufacturing system;

FIG. 4 is a schematic diagram of gas flow during operation of the additive manufacturing system shown in FIG. 1 with the vane located adjacent a top of the housing of the additive manufacturing system;

FIG. 5 is a schematic diagram of gas flow during operation of the additive manufacturing system shown in FIG. 1 with a first vane located adjacent the wall of the housing and a second vane located adjacent the outlet; and

FIG. 6 is a flow chart of an exemplary method of fabricating a component using the additive manufacturing system shown in FIGS. 1-5.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “substantially,” and “approximately,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Additive manufacturing processes and systems include, for example, and without limitation, vat photopolymerization, powder bed fusion, binder jetting, material jetting, sheet lamination, material extrusion, directed energy deposition and hybrid systems. These processes and systems include, for example, and without limitation, SLA—Stereolithography Apparatus, DLP—Digital Light Processing, 3SP—Scan, Spin, and Selectively Photocure, CLIP—Continuous Liquid Interface Production, SLS—Selective Laser Sintering, DMLS—Direct Metal Laser Sintering, SLM—Selective Laser Melting, EBM—Electron Beam Melting, SHS—Selective Heat Sintering, MJF—Multi-Jet Fusion, 3D Printing, Voxeljet, Polyjet, SCP—Smooth Curvatures Printing, MJM—Multi-Jet Modeling ProJet, LOM—Laminated Object Manufacture, SDL—Selective Deposition Lamination, UAM—Ultrasonic Additive Manufacturing, FFF—Fused Filament Fabrication, FDM—Fused Deposition Modeling, LMD—Laser Metal Deposition, LENS—Laser Engineered Net Shaping, DMD—Direct Metal Deposition, Hybrid Systems, and combinations of these processes and systems. These processes and systems may employ, for example, and without limitation, all forms of electromagnetic radiation, heating, sintering, melting, curing, binding, consolidating, pressing, embedding, and combinations thereof.

Additive manufacturing processes and systems employ materials including, for example, and without limitation, polymers, plastics, metals, ceramics, sand, glass, waxes, fibers, biological matter, composites, and hybrids of these materials. These materials may be used in these processes and systems in a variety of forms as appropriate for a given material and the process or system, including, for example, and without limitation, as liquids, solids, powders, sheets, foils, tapes, filaments, pellets, liquids, slurries, wires, atomized, pastes, and combinations of these forms.

The systems and methods described herein include an additive manufacturing system including a controllable vane that directs gas flow across a build platform. The vane is positionable in a plurality of different orientations relative to the gas flow. The additive manufacturing system includes a control system that adjusts the orientation of the vane based on information from a sensor positioned within the build chamber. Accordingly, the additive manufacturing system is able to adjust the operating parameters of the environment by changing the orientation of the vane. Moreover, the additive manufacturing system is able to accommodate changes in environmental conditions such as a build-up of heat and/or particles during operation of the additive manufacturing system to ensure proper fabrication of the component.

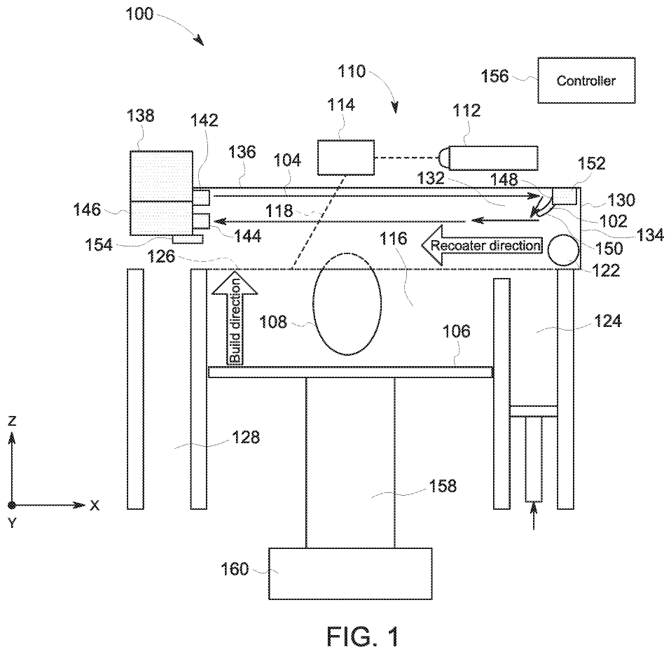

FIG. 1 is a schematic view of an exemplary additive manufacturing system 100 including a vane or airfoil 102 that directs a gas flow 104 across a build platform 106. A coordinate system of additive manufacturing system 100 includes an X-axis, a Y-axis, and a Z-axis. Additive manufacturing system 100 builds objects, for example, a part or component 108. In the exemplary embodiment, additive manufacturing system 100 includes a consolidation device 110 including a laser device 112 and a scanning device 114. Additive manufacturing system 100 is configured for fabricating component 108 using a layer-by-layer manufacturing process by sintering or melting a particulate 116 using an energy beam 118 generated by a source such as laser device 112. For example, in some embodiments, additive manufacturing system 100 is used for direct metal laser sintering (DMLS) or direct metal laser melting (DMLM). Laser device 112 provides a high-intensity heat source configured to generate a melt pool in a bed of particulate 116 using energy beam 118. Alternatively, consolidation device 110 may include any component that facilitates consolidation of a material using any of the processes and systems described herein.

In the exemplary embodiment, additive manufacturing system 100 further includes build platform 106, a recoater arm 122, and a reservoir 124. During operation of additive manufacturing system 100, particulate 116 is supplied by reservoir 124 and spread evenly over build platform 106 using recoater arm 122. Recoater arm 122 is configured to maintain the particulate at a particulate level 126 and remove excess particulate material extending above particulate level 126 to a particulate container 128. Energy beam 118 consolidates particulate 116 to form a cross-sectional layer of component 108. After selective consolidation of the layer of particulate 116, build platform 106 is lowered and another layer of particulate 116 is spread over build platform 106 and component 108, followed by successive consolidation of the layer of particulate 116 by laser device 112. The process is repeated until component 108 is completely built up from the consolidated portion of particulate 116.

In addition, in the exemplary embodiment, additive manufacturing system 100 includes a housing 130 surrounding build platform 106 and defining an environment 132 for forming component 108. Housing 130 includes at least one sidewall 134 extending around the perimeter of build platform 106. Housing 130 also includes a top 136 coupled to sidewall 134 and positioned opposite build platform 106. In some embodiments, housing 130 includes one or more windows to provide a line of sight into the build chamber from an exterior of housing 130. In addition, in some embodiments, housing 130 includes a removable or positionable panel providing access into environment 132. In alternative embodiments, additive manufacturing system 100 includes any housing 130 that enables additive manufacturing system 100 to operate as described herein.

Also, in the exemplary embodiment, additive manufacturing system 100 includes a gas supply 138 configured to provide gas flow 104 across build platform 106 during fabrication of component 108. For example, gas flow 104 provides an inert atmosphere and maintains oxidation and fuel to oxygen ratios of environment 132 below threshold values. Housing 130 includes an inlet 142 to direct gas flow 104 into environment 132 from gas supply 138 and an outlet 144 for gas flow 104 to exit environment 132. In some embodiments, additive manufacturing system 100 includes an exhaust system 146 coupled to outlet 144 to process gas flow 104 after gas flow 104 exits housing 130 through outlet 144. Exhaust system 146 may include one or more filters or scrubbers configured to process gas flow 104 and remove particulates such as soot. In some embodiments, at least a portion of gas flow 104 is recirculated through gas supply 138 after flowing through exhaust system 146. Gas supply 138 is configured to provide a predetermined pressure and flow rate into environment 132. In the exemplary embodiment, gas flow 104 includes any suitable gases and particulates. In alternative embodiments, additive manufacturing system 100 includes any gas supply 138 that enables additive manufacturing system 100 to operate as described herein.

Moreover, in the exemplary embodiment, vane 102 is positioned within environment 132 in the path of gas flow 104. Accordingly, vane 102 is configured to contact gas flow 104 and direct gas flow 104 across build platform 106. In some embodiments, vane 102 includes at least one control surface. In the exemplary embodiment, vane 102 includes an upper surface 148 that forms a first side of vane 102 and a lower surface 150 that forms a second side of vane 102. In the exemplary embodiment, upper surface 148 is concave and lower surface 150 is convex. In some embodiments, upper surface 148 and/or lower surface 150 is at least partially planar. Vane 102 extends across the width of build platform 106 between sidewalls 134 of housing 130. In alternative embodiments, additive manufacturing system 100 includes any vane 102 that enables additive manufacturing system 100 to operate as described herein.

Also, in the exemplary embodiment, vane 102 is positionable in a plurality of orientations by an actuator system 152 coupled to vane 102. Actuator system 152 includes, for example and without limitation, a linear motor, a rotary motor, a hydraulic and/or pneumatic piston(s), and/or a mechanical actuator component such as a screw drive mechanism(s), and/or a conveyor system. In the exemplary embodiment, vane 102 is pivotably coupled to housing 130 and actuator system 152 is configured to rotate vane 102 about a rotation axis extending through vane 102. In alternative embodiments, actuator system 152 is configured to translate vane 102 in one or more of the X-direction, the Y-direction, and the Z-direction in addition to or instead of rotating vane 102. For example, in some embodiments, actuator system 152 is configured to move vane 102 along a track coupled to housing 130. In alternative embodiments, additive manufacturing system 100 includes any actuator system 152 that enables additive manufacturing system 100 to operate as described herein.

The angle of vane 102 relative to gas flow 104, i.e., the angle of attack of vane 102, dictates how gas flow 104 moves around vane 102. Actuator system 152 is configured to adjust the orientation of vane 102 such that the angle of vane 102 relative to gas flow 104 changes as actuator system 152 moves vane 102. As a result, the direction of gas flow 104 within environment 132 is altered by vane 102.

In addition, in the exemplary embodiment, additive manufacturing system 100 includes at least one sensor 154 disposed at least partially within environment 132. Sensor 154 is configured to detect a condition of environment 132 and/or gas flow 104 such as, for example and without limitation, a pressure, a flow rate, an airspeed, a temperature, and a particulate level. Sensor 154 may be a pressure sensor, a temperature sensor, an anemometer, an optical sensor, and/or an auditory sensor. In alternative embodiments, additive manufacturing system 100 includes any sensor 154 that enables additive manufacturing system 100 to operate as described herein.

Moreover, in the exemplary embodiment, additive manufacturing system 100 also includes a computer control system, or controller 156. Controller 156 controls consolidation device 110 to facilitate directing energy beam 118 along the surface of particulate 116 of a build layer to form a layer of component 108. For example, scanning device 114 is controlled by controller 156 and is configured to move a mirror such that energy beam 118 is reflected to be incident along a predetermined scan path along build platform 106, such as, for example, and without limitation, a linear, rotational, and/or asymmetric scan path. In some embodiments, scanning device 114 includes a two-dimension scan galvanometer, a three-dimension (3D) scan galvanometer, dynamic focusing galvanometer, and/or any other scanning device that may be used to deflect energy beam 118 of laser device 112. In alternative embodiments, energy beam 118 is moved in any orientation and manner that enables additive manufacturing system 100 to operate as described herein.

Also, in the exemplary embodiment, controller 156 is communicatively coupled to sensor 154 and is configured to determine an operating parameter of environment 132 such as an air quality parameter and/or a temperature based on information from sensor 154. Based on the determined operating parameter, controller 156 selects a desired orientation of vane 102 to provide a desired gas flow 104. For example, in some embodiments, controller 156 adjusts the orientation of vane 102 to provide a desired temperature distribution and adjust a cooling rate within environment 132. In further embodiments, controller 156 adjusts the orientation of vane 102 to increase the amount of soot or particles that are carried away from build platform 106 by gas flow 104. In some embodiments, controller 156 adjusts the orientation of vane 102 to direct gas flow 104 towards and provide a cleaning operation for components of additive manufacturing system 100 such as a window of housing 130. In alternative embodiments, controller 156 adjusts the orientation of vane 102 in any manner that enables additive manufacturing system 100 to operate as described herein.

In addition, in the exemplary embodiment, controller 156 sends signals to actuator system 152 to cause actuator system 152 to move vane 102 between the plurality of orientations based on the information from sensor 154. For example, controller 156 sends motor control signals to a motor of actuator system 152. After receiving the signals, actuator system 152 rotates vane 102 about the rotation axis or otherwise changes the orientation of vane 102 to change the angle of attack of vane 102 relative to gas flow 104.

Moreover, in the exemplary embodiment, build platform 106 is mounted to a support structure 158, which is moved by an actuator system 160. Actuator system 160 is configured to move support structure 158 in the Z-direction (i.e., normal to a top surface of build platform 106). In some embodiments, actuator system 160 is also configured to move support structure 158 in the XY plane. For example, and without limitation, in an alternative embodiment, actuator system 160 moves support structure 158 in the XY plane to cooperate with scanning device 114 and direct energy beam 118 of laser device 112 along the scan path about build platform 106. In the exemplary embodiment, actuator system 160 includes, for example and without limitation, a linear motor(s), a hydraulic and/or pneumatic piston(s), a screw drive mechanism(s), and/or a conveyor system.

In the exemplary embodiment, additive manufacturing system 100 is operated to fabricate component 108 from a computer modeled representation of the 3D geometry of component 108. The computer modeled representation may be produced in a computer aided design (CAD) or similar file. The CAD file of component 108 is converted into a layer-by-layer format that includes a plurality of build parameters for each layer of component 108. For example, a build layer of component 108 includes a particulate to be consolidated by additive manufacturing system 100. In the exemplary embodiment, component 108 is modeled in a desired orientation relative to the origin of the coordinate system used in additive manufacturing system 100. The geometry of component 108 is sliced into a stack of layers of a desired thickness, such that the geometry of each layer is an outline of the cross-section through component 108 at that particular layer location. Scan paths are generated across the geometry of a respective layer. The build parameters are applied along each scan path to fabricate that layer of component 108 from particulate 116 used to construct component 108. The steps are repeated for each respective layer of component 108 geometry. Once the process is completed, an electronic computer build file (or files) is generated, including all of the layers. The build file is loaded into controller 156 of additive manufacturing system 100 to control the system during fabrication of each layer.

After the build file is loaded into controller 156, additive manufacturing system 100 is operated to generate component 108 by implementing the layer-by-layer manufacturing process, such as a direct metal laser melting method. The exemplary layer-by-layer additive manufacturing process does not use a pre-existing article as the precursor to the final component, rather the process produces component 108 from a raw material in a configurable form, such as particulate 116. For example and without limitation, a steel component can be additively manufactured using a steel powder. Additive manufacturing system 100 enables fabrication of components, such as component 108, using a broad range of materials, for example and without limitation, metals, ceramics, glass, and polymers.

During operation of additive manufacturing system 100, sensor 154 provides real-time measurements of environmental conditions within housing 130. For example, in some embodiments, sensor 154 is configured to provide information relating to air quality within environment 132 and controller 156 is configured to determine when an amount of soot or particles at a location within environment 132 is greater than a threshold value. In addition, in some embodiments, sensor 154 is configured to provide information relating to a temperature of environment 132 and controller 156 is configured to determine when the temperature at a location within environment 132 is greater or less than a threshold value. Controller 156 is configured to adjust the orientation of vane 102 based on the information from sensor 154. For example, in some embodiments, controller 156 adjusts the orientation of vane 102 to provide increased/decreased cooling and/or removal of particles at locations within environment 132.

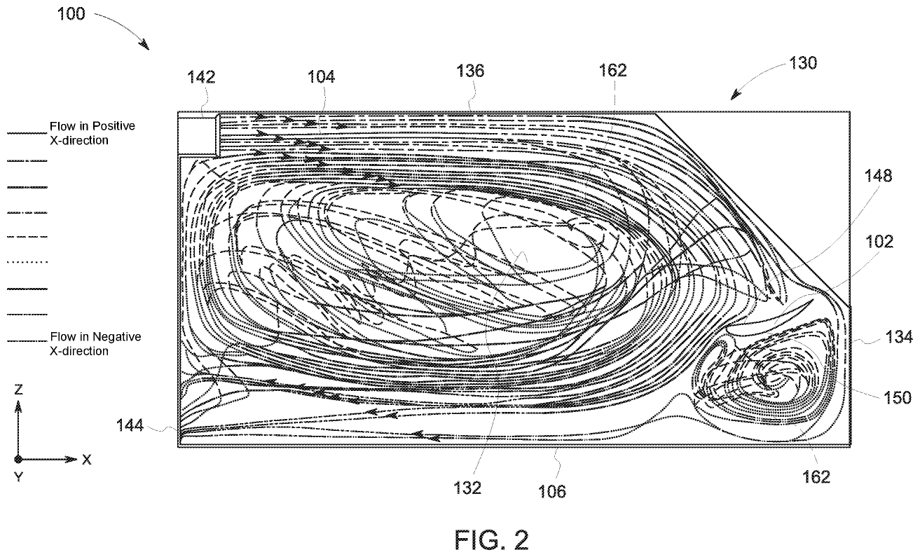

FIG. 2 is a schematic diagram of gas flow 104 during operation of additive manufacturing system 100 with vane 102 located at a distance from inlet 142 and outlet 144. Gas flow 104 flows into housing 130 through inlet 142. Inlet 142 is located adjacent top 136 and gas flow 104 travels along top 136 towards sidewall 134. In some embodiments, sidewall 134 is at least partially angled. Sidewall 134 redirects gas flow 104 away from top 136 and towards build platform 106. At least a portion of gas flow 104 exits housing 130 through outlet 144. Accordingly, gas flow 104 generally moves from inlet 142 to outlet 144. Vane 102 is positioned at a distance from inlet 142 and outlet 144 within the path of gas flow 104. The orientation of vane 102 generates flow fields 162 within gas flow 104. Such flow fields 162 change localized characteristics of gas flow 104 such as flowrate, airspeed, temperature, and pressure and, as a result, may provide desired operating parameters within locations of environment 132. Accordingly, controller 156 (shown in FIG. 1) is able to control conditions of the environment within housing 130 by adjusting the orientation of vane 102. For example, the orientation of vane 102 shown in FIG. 2 generates flow fields 162 adjacent sidewall 134 which may provide increased cooling to a portion of build platform 106.

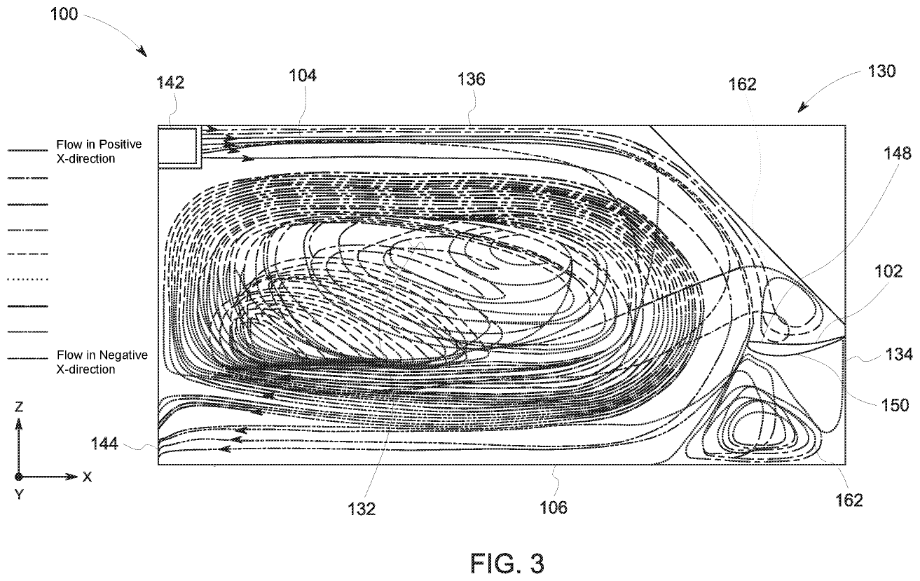

FIG. 3 is a schematic diagram of gas flow 104 during operation of additive manufacturing system 100 with vane 102 located adjacent sidewall 134 of housing 130 of additive manufacturing system 100. Gas flow 104 flows into housing 130 through inlet 142. Inlet 142 is located adjacent top 136 and gas flow 104 travels along top 136 towards sidewall 134. Vane 102 is located adjacent sidewall 134 and directs gas flow 104 away from sidewall 134. The orientation of vane 102 generates flow fields 162 within gas flow 104. For example, flow fields 162 are located adjacent build platform 106 and sidewall 134.

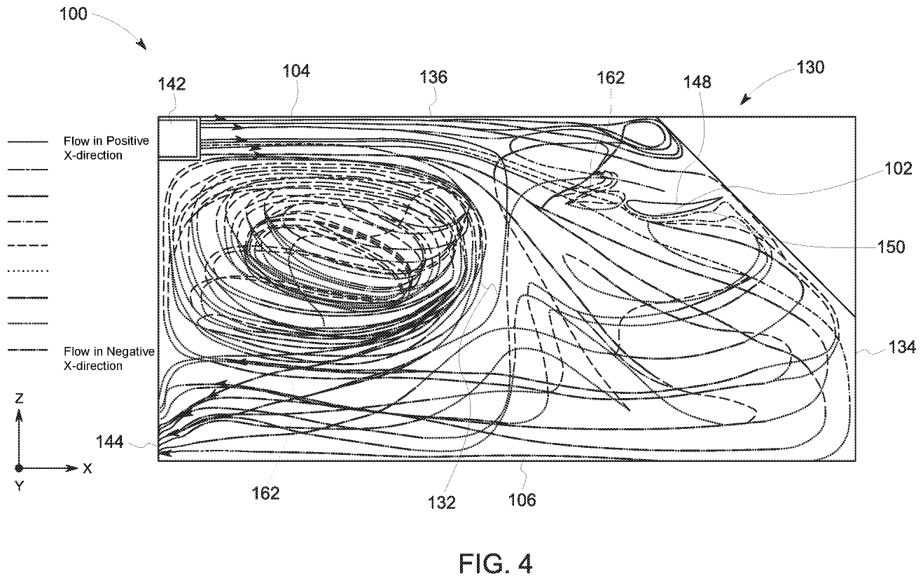

FIG. 4 is a schematic diagram of gas flow 104 during operation of additive manufacturing system 100 with vane 102 located adjacent a top of housing 130 of additive manufacturing system 100. Gas flow 104 flows into housing 130 through inlet 142. Inlet 142 is located adjacent top 136 and gas flow 104 travels along top 136 towards sidewall 134. Vane 102 is located adjacent sidewall 134 closer to top 136 than to build platform 106. Accordingly, vane 102 restricts gas flow 104 along sidewall 134. The orientation of vane 102 generates flow fields 162 within gas flow 104. Flow fields 162 are located adjacent top 136 and at a distance from sidewall 134.

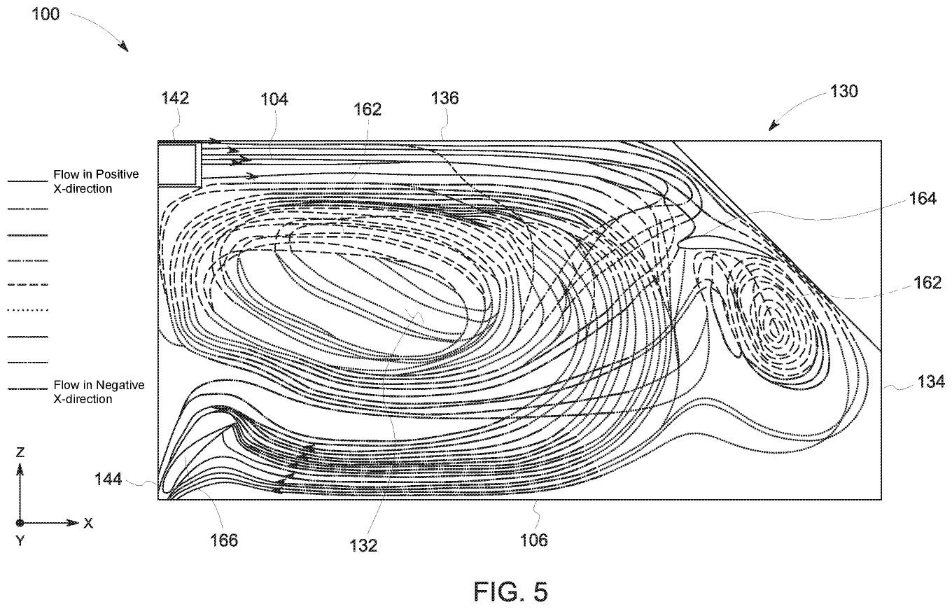

FIG. 5 is a schematic diagram of gas flow 104 during operation of additive manufacturing system 100 with a first vane 164 located adjacent sidewall 134 of housing 130 and a second vane 166 located adjacent outlet 144. Gas flow 104 flows into housing 130 through inlet 142. Inlet 142 is located adjacent top 136 and gas flow 104 travels along top 136 towards sidewall 134. First vane 164 is located adjacent sidewall 134. Second vane 166 is located outlet 144. Accordingly, vanes 164, 166 restrict gas flow 104 along sidewall 134 and at outlet 144. The orientation of vanes 164, 166 generates flow fields 162 within gas flow 104. Flow fields 162 are located at multiple locations throughout substantially the entire environment of housing 130 due to the positions of vanes 164, 166.

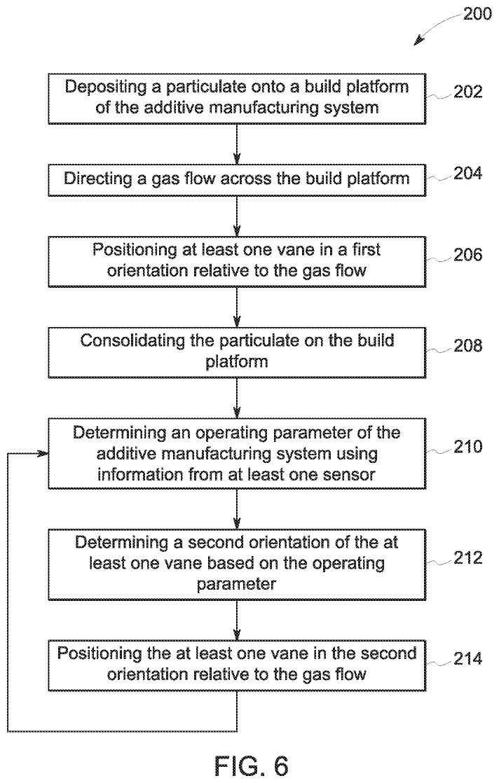

FIG. 6 is a flow chart of an exemplary method 200 of fabricating component 108 (shown in FIG. 1) using additive manufacturing system 100. In reference to FIGS. 1 and 6, method 200 generally includes depositing 202 particulate 116 onto build platform 106 of additive manufacturing system 100 and directing 204 gas flow 104 across build platform 106. Gas flow 104 may be provided by gas supply 138 coupled to inlet 142. Gas flow 104 generally travels from inlet 142 to outlet 144 where gas flow 104 is exhausted from housing 130.

In the exemplary embodiment, method 200 further includes positioning 206 vane 102 in a first orientation relative to gas flow 104. For example, vane 102 is located adjacent top 136, sidewall 134, build platform 106, inlet 142, and/or outlet 144. Vane 102 directs gas flow 104 across build platform 106 and, in some embodiments, is orientated to generate flow fields 162 (shown in FIGS. 2-5) in gas flow 104.

Method 200 also includes consolidating 208 particulate 116 on build platform 106. For example, consolidation device 110 is configured to travel along the scan path and consolidate particulate 116 to form component 108. In the exemplary embodiment, additive manufacturing system 100 uses a layer-by-layer process in which component 108 is fabricated by depositing and consolidating successive layers of particulate 116. For example, after completion of each layer, method 200 determines if component 108 includes another layer. If component 108 includes another layer, additional particulate 116 is deposited onto build platform 106 and consolidated. The process of depositing and consolidating particulate 116 is repeated until component 108 is fully formed, i.e., until controller 156 determines that component 108 does not include another layer.

In addition, in the exemplary embodiment, method 200 includes determining 210 an operating parameter of additive manufacturing system 100 using information from at least one sensor 154. In some embodiments, sensor 154 is configured to detect at least one of a pressure, a flow rate, an airspeed, a particulate level, and a temperature of gas flow 104 and/or environment 132. Sensor 154 sends information to controller 156 and controller 156 determines 210 the operating parameter based on the information. For example, in some embodiments, controller 156 determines at least one of an air quality parameter and a temperature distribution of environment 132.

Moreover, in the exemplary embodiment, method 200 includes determining 212 a second orientation of vane 102 based on the operating parameter and positioning 214 vane 102 in the second orientation relative to gas flow 104. For example, controller 156 determines a second orientation of vane 102 that will affect gas flow 104 and provide a desired change to conditions of environment 132. In some embodiments, controller 156 determines an orientation of vane 102 that directs gas flow 104 towards specific portions of build platform 106. For example, controller 156 may determine an orientation of vane 102 that provides increased cooling to a portion of build platform 106. In further embodiments, controller 156 determines an orientation of vane 102 that provides a change in the rate that gas flow 104 moves through and is exhausted from housing 130. For example, controller 156 may increase the flow rate of gas flow 104 through housing 130 to provide increased cooling to build platform 106 and/or component 108. Alternatively, controller 156 may decrease the flow rate of gas flow 104 to reduce heat removal from environment 132 and thereby increase the temperature of environment 132.

Controller 156 moves vane 102 between the first orientation and the second orientation by sending a control signal to actuator system 152. In some embodiments, actuator system 152 pivots vane 102 relative to housing 130 about a rotation axis extending through vane 102 to move vane 102 between the first orientation and the second orientation. In further embodiments, actuator system 152 translates vane 102 in at least one of the X-direction, the Y-direction, and the Z-direction relative to housing 130 to move vane 102 between the first orientation and the second orientation. In some embodiments, actuator system 152 moves vane 102 along a track coupled to housing 130 in at least one of the X-direction, the Y-direction, and the Z-direction.

In the exemplary embodiments, method 200 includes a continuous feedback loop and controller 156 continuously controls the operating parameters of additive manufacturing system 100 in real time by repeatedly adjusting the orientation of vane 102 during operation of additive manufacturing system 100. For example, sensor 154 provides information to controller 156 as a continuous stream or as a repeated sampling. After an adjustment to the orientation of vane 102, controller 156 compares the information from sensor 154 to desired operating parameters to determine if the adjusted orientation of vane 102 provided the desired effect on environment 132. In addition, after desired operating parameters are reached, controller 156 and sensor 154 continuously monitor the conditions of environment 132 to determine if operating parameters remain within desired ranges. If necessary, after receiving information from sensor 154, controller 156 determines a new (second, third, fourth, etc.) orientation of vane 102 and causes vane 102 to move to the new orientation. After adjusting vane 102, controller 156 compares the information from sensor 154 to desired operating conditions and further adjusts vane 102 if necessary.

The embodiments described herein include an additive manufacturing system including a controllable vane that directs gas flow across a build platform. The vane is positionable in a plurality of different orientations relative to the gas flow. The additive manufacturing system includes a control system that adjusts the orientation of the vane based on information from a sensor positioned within the build chamber. Accordingly, the additive manufacturing system is able to adjust the operating parameters of the environment by changing the orientation of the vane. Moreover, the additive manufacturing system is able to accommodate changes in environmental conditions such as a build-up of heat and/or soot during operation of the additive manufacturing system to ensure proper fabrication of the component.

An exemplary technical effect of the methods, systems, and apparatus described herein includes at least one of: a) increasing the purity of components fabricated using an additive manufacturing process, b) providing real-time feedback and control of environmental conditions within an additive manufacturing system, c) reducing the time required for additively manufacturing a component by providing increased cooling for the component, and d) reducing the cost of additively manufacturing a component.

Exemplary embodiments of additive manufacturing systems are described above in detail. The additive manufacturing systems, and methods of using and manufacturing such systems are not limited to the specific embodiments described herein, but rather, components of systems and/or steps of the methods may be utilized independently and separately from other components and/or steps described herein. For example, the methods may also be used in combination with other additive manufacturing systems, and are not limited to practice with only the additive manufacturing systems, and methods as described herein. Rather, the exemplary embodiment can be implemented and utilized in connection with many other additive manufacturing systems.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An additive manufacturing system comprising:
a build platform configured to receive a particulate;
a consolidation device configured to consolidate the particulate to form a component;
a gas supply configured to provide a gas flow across said build platform;
at least one vane positionable in a plurality of orientations relative to the gas flow;
an actuator system coupled to said at least one vane and configured to move said at least one vane between the plurality of orientations;
at least one sensor; and
a control system configured to receive information from said at least one sensor and cause said at least one vane to move between the plurality of orientations based on the information received from said at least one sensor.

2. The additive manufacturing system in accordance with claim 1 further comprising a housing surrounding the build platform and defining an environment for forming the component, wherein said housing includes an inlet to receive the gas flow into the environment from said gas supply and an outlet for the gas flow to exit the environment, said at least one sensor disposed at least partially within the environment.

3. The additive manufacturing system in accordance with claim 2, wherein said at least one vane is coupled to said housing and located adjacent at least one of said inlet and said outlet.

4. The additive manufacturing system in accordance with claim 2, wherein said at least one vane is coupled to said housing and spaced from said inlet and said outlet.

5. The additive manufacturing system in accordance with claim 2, wherein said at least one vane is pivotably coupled to said housing, and wherein said actuator system is configured to rotate said at least one vane about a rotation axis.

6. The additive manufacturing system in accordance with claim 2, wherein said at least one sensor comprises at least one of a pressure sensor, a temperature sensor, an anemometer, an optical sensor, and an auditory sensor.

7. The additive manufacturing system in accordance with claim 6, wherein said control system is configured to determine an air quality parameter of the environment based on the information received from said at least one sensor and adjust an orientation of said at least one vane based on the air quality parameter.

8. The additive manufacturing system in accordance with claim 1, wherein said actuator system is configured to move said at least one vane along a track.

9. The additive manufacturing system in accordance with claim 1 further comprising a motor coupled to said actuator system and configured to receive control signals from said control system for moving said at least one vane between the plurality of orientations.

10. A method of fabricating a component using an additive manufacturing system, said method comprising:
depositing a particulate onto a build platform of the additive manufacturing system;
directing a gas flow across the build platform;
positioning at least one vane in a first orientation relative to the gas flow;
consolidating the particulate on the build platform;
determining an operating parameter of the additive manufacturing system using information received from at least one sensor;
determining a second orientation of the at least one vane based on the operating parameter; and
positioning the at least one vane in the second orientation relative to the gas flow.

11. The method in accordance with claim 10, wherein a housing surrounds the build platform and defines an environment for forming the component, said method further including supplying the gas flow to the environment through an inlet in the housing and directing the gas flow to exit the environment through an outlet in the housing.

12. The method in accordance with claim 11 wherein the at least one sensor is disposed at least partially within the environment defined by the housing.

13. The method in accordance with claim 12, wherein determining an operating parameter of the additive manufacturing system comprises determining an air quality parameter of the environment based on the information received from the at least one sensor.

14. The method in accordance with claim 10, wherein positioning the at least one vane in the second orientation comprises rotating the at least one vane about a rotation axis.

15. The method in accordance with claim 10, wherein positioning the at least one vane in the second orientation comprises moving the at least one vane along a track.

16. The method in accordance with claim 10, wherein positioning the at least one vane in the second orientation comprises positioning the at least one vane using an actuator system.

17. The method in accordance with claim 16, further comprising sending control signals to a motor coupled to the actuator system to cause the actuator system to position the at least one vane in the second orientation.

18. The method in accordance with claim 10, wherein the at least one sensor includes at least one of a pressure sensor, a temperature sensor, and an anemometer.

19. An additive manufacturing system comprising:
a build platform configured to receive a particulate;
a gas supply configured to provide a gas flow across said build platform;
a housing surrounding said build platform and defining an environment for forming a component, wherein said housing includes an inlet to receive the gas flow into the environment from said gas supply and an outlet for the gas flow to exit the environment;
at least one vane movably coupled to said housing and disposed within the environment, wherein said at least one vane is positionable in a plurality of orientations relative to the gas flow; and
a control system configured to determine at least one operating parameter of said additive manufacturing system and move said at least one vane between the plurality of orientations based on the operating parameter.

20. The additive manufacturing system of claim 19 further comprising at least one sensor positioned within the environment and configured to transmit information to said control system relating to the operating parameter of the additive manufacturing system.
